(19) United States
(12) Patent Application Publication
(10) Pub. No.: US 2008/0307069 A1
(43) Pub. Date: Dec. 11, 2008

(54) USE OF A PREFIX HASH TABLE (PHT) FOR LOCATING SERVICES WITHIN A PEER-TO-PEER COMMUNICATION NETWORK

(75) Inventors: Thomas FROMENT, Longpont Sur Orge (FR); Jean-Francois Wauthy, Namur (BE)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/133,845

(22) Filed: Jun. 5, 2008

(30) Foreign Application Priority Data
Jun. 8, 2007 (FR) 0755592

(51) Int. Cl. G06F 15/16

(52) U.S. Cl. 709/218

(57) ABSTRACT

A communication network (NET) including a distributed hash table (DHT) whose nodes (X₁, X₂, X₃ . . . X_{N}) provide services that may be accessed by network elements (T), and which has:
means for receiving a service location request (R) containing at least one service identifier (ID), and
search means for searching the hash table for at least one piece of location information.

The invention is characterized in that the hash table is organized so that the location information is associated with keys which contain at least one service identifier and which correspond to leaves on a PHT binary tree whose node labels are distributed within the hash table; and in that the search means are adapted to search for location information in all or some of the leaves whose label prefixes the service identifier contained within the service request.

This invention pertains to the field of peer-to-peer communication networks. More particularly, it pertains to locating a service within such a peer-to-peer network.

Peer-to-peer communications have gradually emerged as effective alternatives for certain types of services. For example, the company Skype has built its success on a peer-to-peer model for establishing voice-over-IP (VoIP) or multimedia-over-IP communication sessions.

Other content exchange services are also based on peer-to-peer technology, such as the eMule, Bittorrent, and JXTA network, among others.

The founding principle of a peer-to-peer network resides in the absence of a central body: the service logic is distributed across all of the elements of the peer-to-peer network; each element can potentially be both a client (requesting a service) and a server (providing a service).

Many peer-to-peer networks are based on a distributed hash table.

A distributed hash table is a technology for memorizing and recovering information within a massively distributed system, such as a peer-to-peer network. In principle, the contents of the hash table are distributed across all of the peers or nodes on the network, and there is no centralized device.

Such distributed hash tables are described, among other places, in the article Looking up Data in P2P Systems by H. Balakrishna, F. Kaashoek, D. Karger, R. Morris and I. Stoica, published in February 2003, in the journal Communications of the ACM, vol. 46, no. 2.

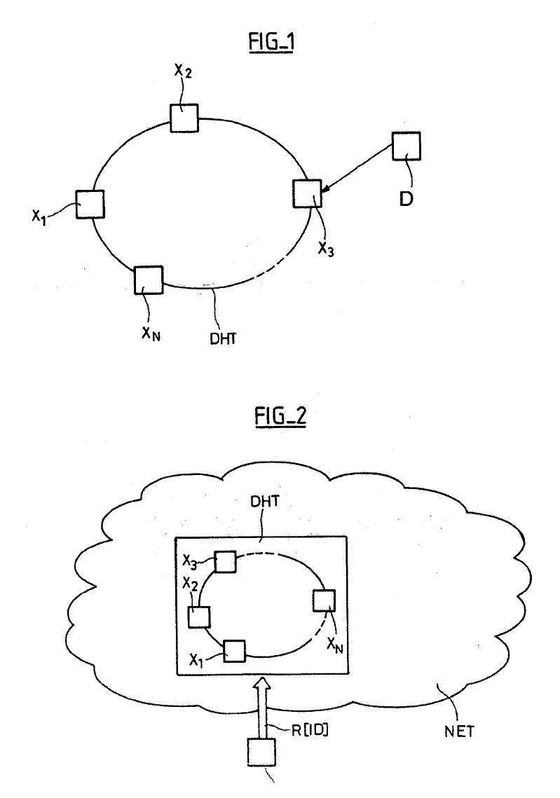

FIG. 1 depicts a distributed hash table DHT made up of nodes X₁, X₂, X₃ . . . X_{N}.

A piece of information is saved within the DHT network by associating it with a key K and applying a hash function H to that key. The value H(K) determines an index for identifying a particular node within the network (for example, the closest node with index i, or the one that is just lower . . . ).

The same process may be implemented in order to recover information.

The information saving and recovery mechanisms have already been explained in numerous publications on the subject that are available to a person skilled in the art. Furthermore, they will be described slightly further later in the description.

It is important here to note the fully distributed nature of the saving process, and the fact that in this manner, the space for the information to be saved can be split up into storage space made up of N nodes.

This distributed aspect is interesting in more than one way for communication network architectures, as well as for voice-over-IP (VoIP)/multimedia-over-IP (Internet Protocol) applications.

It also makes it possible to overcome certain burdens that centralized systems have: the increased size of the centralized system when the number of subscribers to the service is high; the necessity and complexity of maintaining it; handling its crashes and downtime; etc.

The eventual success of peer-to-peer architecture has spurred the IETF (the Internet Engineering Task Force) to weigh in on defining a particular architecture for services based on the Session Initiation Protocol (SIP).

The SIP protocol is defined by the IETF's RFC 3261 and is designed to carry the signaling needed to negotiate and establish multimedia sessions on networks for communicating data based on Internet Protocol (IP).

This work is currently being undertaken by the P2P-SIP (for “peer-to-peer SIP”) workgroup of the IETF.

One document describing this work is the IETF draft entitled dSIP: A P2P Approach to SIP Registration and Resource Location, and published in February 2007 under the name “draft-bryan-p2 psip-dsip-00”.

The SIP protocol requires a certain number of services (such as the “Registrar”), which may be implemented by a distributed hash table rather than by a centralized server.

These services may also include
STUN (Simple Traversal of User Datagram Protocol (UDP) through Network Address Translators (NATs)), defined by RFC 3489
TURN (“Traversal Using Relay NAT”), published in September 2005 with the status of “IETF draft” under the name “draft-rosenberg-midcom-turn-08.txt”
a media relay,
a presence service, etc.

These services may be provided by one or more nodes of the distributed hash table, but this raises the issue of how the SIP clients, or other network elements, are to locate them.

Several possibilities for solutions have been mentioned in discussions of IETF workgroups.

A first approach consists of using a single centralized service whose purpose is to maintain associations between services and the addresses of the servers that provide them. This server should have an address that is determined well, so that the clients can contact it easily. In this manner, a client looking for a STUN server would send it a service request containing “STUN” as a parameter, and would receive a list of addresses, with each address corresponding to a node of the distributed hash table providing that service.

This first approach, however, is not satisfactory, as it introduces a centralized server, which is contrary to the very philosophy of a peer-to-peer network. The abovementioned drawbacks of centralized approaches, which led to the creation and success of peer-to-peer approaches, thus also apply here, particularly the fact that this server becomes a weak point in the architecture: if failure occurs, the clients will no longer be able to locate the servers (nodes) that provide the services being searched for. Furthermore, this centralized server is a preferred target for mischievous denial of service (DOS) attacks.

The alternative therefore consists of saving location information to the distributed hash table itself.

A first solution in accordance with this approach consists of associating a key with a set of location information. This idea had been submitted to the mailing list of the P2P SIP workgroup of IETF in December 2006.

However, it suffers from several drawbacks. In particular, if the number of services and the number of nodes in the distributed hash table are high, the location information may take up a great deal of space.

This can cause sizing problems in the node that is handling this information: According to the basic principle of a distributed hash table, there is no way to check which node is handling a given piece of information, as the table is self-managing. Furthermore, location information can be managed by a node with limited capacity, such as a communication client, in an architecture where the clients are part of the distributed hash table.

In addition to the storage problem, there is also the drawback that this node receives all service requests. This creates an overloaded point within the communication network.

A second solution consists of defining different location information for each instance of service. For example, a prefix can be defined for each service, with an index number for the instance being added to it, in order to form the location information key. This can be used to create a “STUN1” key (associated with a piece of location information containing at least the IP address of a first server providing the STUN service), a “TURN5” key (associated with a piece of location information containing at least the IP address of a fifth server providing the TURN service), etc.

But the problem then arises of how to provide the communication client with information about the keys available (What services are available? What indexes are possible for each service?)

As a distributed hash table can only accept “precise” requests, i.e. a search for a precisely determined key, searching for a piece of location information requires several successive requests so that the client can get all the location information related to a given service (such as “STUN”).

Furthermore, this method is very poor at handling the dynamic aspect of a distributed hash table: whenever the client receives location information from the last server providing the requested service, other servers might be connected to the table, while others would be disconnected. It then becomes impossible for the client to get up-to-date information.

The purpose of this invention is to offer a solution for locating a set of servers that provide a requested service.

A first purpose of the invention is a communication network including a distributed hash table whose nodes provide services that are accessible to network elements connected to the telecommunication network. The distributed hash table has:
means for receiving a service location request from a network element, said request containing at least one service identifier, and
search means for searching for at least one piece of location information within the distributed hash table, and for transmitting it (or them) to the network element.

Each of these pieces of location information corresponds to a node that provides the service, which is determined by the service identifier.

The communication network of the invention is characterized in that
the hash table is organized so that the location information is associated with keys containing at least one service identifier, and which correspond to leaves on a binary PHT tree whose nodes' labels are distributed within the distributed hash table, and
in that the search means are designed for search for location information in all or some of the leaves whose labels prefix the service identifier contained within the service request, and to transmit them to the network element.

In one embodiment of the invention, the network element is a communication client, in particular a communication client designed to communicate using the SIP protocol.

This communication client may be a communication terminal.

The labels and keys may be binary words, with the labels being formed in such a way so that the weight of each bit, in descending order, corresponds to an increasing level of depth within the binary tree.

The services in question may, for example, be STUN and/or TURN services and/or compliant with the IETF's RFC 3489bis.

The node providing the service may be one of the nodes of the distributed hash table. It may therefore also be a node outside the distributed hash table.

In one implementation of the invention, the labels may be made up of at least one service identifier, a transport protocol indication, a piece of location information, and a port. The location information may, in particular, be an IP address.

These labels may also include all or some of the parameters defining a universal resource identifier, or URI, in accordance with the IETF's RFC 1630.

Another purpose of the invention is a method enabling a communication device to access a service provided by the distributed hash table. This method includes
a step of transmitting a service location request, said request containing a service identifier; and
a step of searching the distributed hash table for at least one piece of location information, with each of these pieces of location information corresponding to a node providing the service.

The method of the invention is characterized in that the search step consists of searching for a key within a PHT binary tree whose nodes' labels are distributed within the distributed hash table.

This key contains at least the service identifier, and the search consists of searching for the location information in all or some of the leaves whose label prefixes the service identifier.

In one embodiment of the invention, the network element is a communication client, in particular a communication client designed to communicate using the SIP protocol. This communication client may be a communication terminal.

Furthermore, the labels and keys may be binary words. The labels may be formed in such a way so that the weight of each bit, in descending order, corresponds to an increasing level of depth within the binary tree.

The services may be STUN and/or TURN services and/or compliant with the IETF's RFC 3489bis.

The node providing the service may, in particular, be one of the nodes of the distributed hash table.

The labels may be made up of at least one service identifier, a transport protocol indication, a piece of location information, and a port. The location information may be an IP address.

The labels may also include all or some of the parameters defining a universal resource identifier, or URI, in accordance with the IETF's RFC 1630.

Another purpose of the invention is a computer program designed to carry out such a method, whenever it is implemented on an information processing device. This device may, in particular, be a distributed system, such as a communication network. In such a situation, various steps of the method may be implemented by different software modules distributed across the different physical devices.

Another purpose of the invention is a computing medium containing such a computer program. This medium may be an optical storage means, such as a CD-ROM or a DVD-ROM. It may also be a hard drive, and therefore a server, from which the computer program may be downloaded.

The invention and its advantage will become clearer in the following description, in conjunction with the attached figures.

FIG. 1, mentioned above, gives a diagram of a distributed hash table.

FIG. 2 depicts one possible architecture in accordance with the invention.

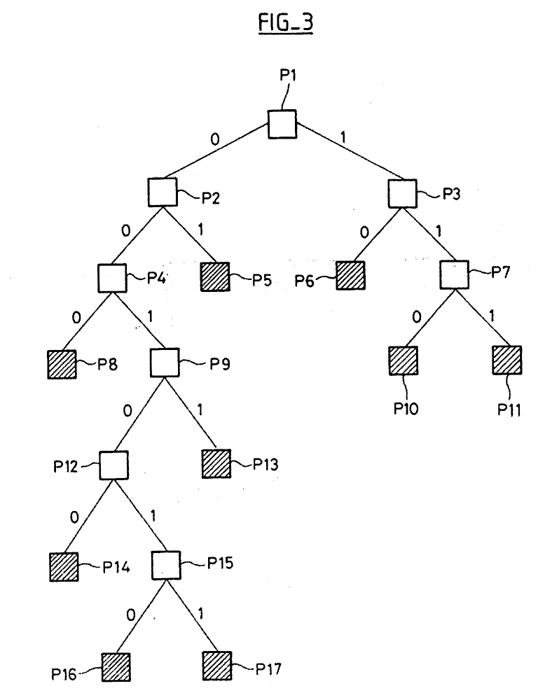

FIG. 3 gives a diagram of an example PHT binary tree.

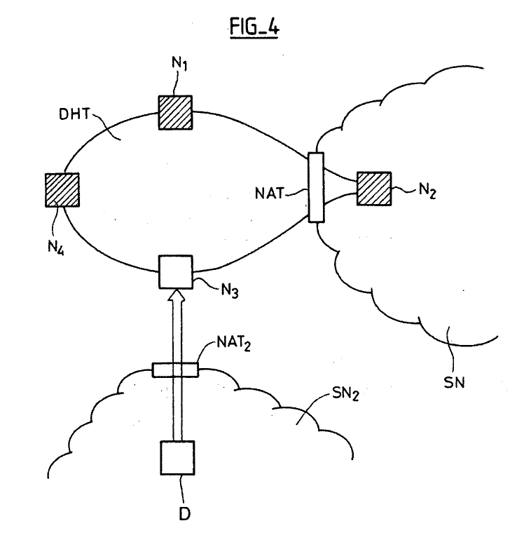

FIG. 4 depicts one application of the invention in locating a STUN server within a communication network.

The architecture depicted by FIG. 2 represents one possible implementation of the invention. A communication network NET includes a distributed hash table DHT made up of a set of nodes X₁, X₂, X₃ . . . X_{N}. In a self-evident manner, the number of these nodes may be dynamic: they may be dynamically drawn from and added to the distributed hash table. The distributed hash table has algorithmic means for handling this dynamic aspect, by redistributing the information within the nodes that make it up.

Network elements may be connected to the communication network NET and access the distributed hash table DHT. The figure shows a direct connection between the network element T and the distributed hash table DHT, but in practice, various types of network devices may be located between these two devices: network address translators NAT, session border controllers SBC, SIP proxies, etc.

The network element T may be a communication client, in particular a communication client designed to communicate with the communication network NET using the SIP protocol. Here, the term “communication client” refers to any device designed for sending requests, in particular SIP requests.

It may, in particular, be a communication terminal, interacting with a human user.

These network elements can send service location requests R, containing at least one identifier ID for a service being searched for. As mentioned above, this service may be a STUN, TURN, or ICE service, a media relay, a presence service, etc.

As the IETF's RFC 3489bis tends to combine the STUN and TURN services into a single service, the service being searched for may also be a “unified service.”

The distributed hash table is designed to receive these location requests. These receiving means may be distributed across all the nodes, or across only some of them.

The service location requests are received from the network element, but they may travel through intermediary devices. In some cases, some of these intermediary devices may interpret the content of service location requests and edit some fields, including determining a final value for the service identifier.

The distributed hash table DHT would, in such a case, have means for search for the location information associated with this service identifier ID. This location information may correspond to one or more nodes of the distributed hash table DHT that provide the service in question. It may, for example, be the IP (“Internet Protocol”) addresses of these nodes.

In one variant, the location information may correspond to nodes outside the distributed hash table DHT. The table serves as a means of location, and the outside node (or server) uses it to register itself as a service provider, and become accessible to the service requesters.

This location information may then be sent to the requesting network element T.

In the invention, the distributed hash table is characterized in that it is organized in such a way so that location information is associated with keys containing at least one service identifier corresponding to leaves on a PHT binary tree, or a prefix hash table).

A PHT binary tree was described in the article “Prefix Hash Tree—An Indexing Data Structure over Distributed Hash Tables” by Sriram Ramabhadran, Sylvia Ratnasamy, Joseph M. Hellerstein, and Scott Shenker, Technical Report, Berkeley Intel Research, February 2004.

It is a structure deployed above a distributed hash table in order to make interval requests. It belongs to the broader category of “tries.” A trie is a data structure that forms an ordered tree used to save an association table, whose keys are strings. A fuller definition of a trie may be found, among other places, in Donald Knuth's work The Art of Computer Programming, volume 3: Sorting and Searching. Third Edition, Addison-Wesley, 1997, pages 492-512.

In a PHT, the strings are binary strings.

Normally, in a PHT, nodes' labels are not saved within the nodes, but they can be deduced from the nodes' positions within the tree.

FIG. 3 gives a diagram of a PHT.

Each node has either two “child” nodes or none. If there are none, it is called a “leaf” of the binary tree. In the figure, nodes p5, p6, p8, p10, p11, p13, p14, p16, and p17 are leaves.

This property guarantees that leaves of a PHT binary tree form a set of universal prefixes: for each key, there is only one leaf whose label is a prefix of that key.

When a node is not a leaf, each of its two children is connected to it by a branch with a binary value, i.e. either a “0” value (left-hand branches in the figure) or a “1” value (right-hand branches in the figure).

Concatenating the values of the branches beginning from root p1 and extended towards a leaf gives the label of the leaf. For example, leaf p14 has the label “00100”, leaf p10 has the label “110”, etc.

Labeling may therefore be seen as a recursive method: If the label of a node is I, its left and right child nodes will therefore be “I0” and “I1”, respectively.

The keys are saved within the leaves of a PHT binary tree, depending on those leaves' labels. More specifically, a key K is saved in a leaf whose label is a prefix of key K.

The following table gives an example, drawn from the abovementioned article, of the matches between keys and matching leaves for the example shown in FIG. 3.

| Leaves | Labels | Keys |
|---|---|---|
| P8 | 000 | 000001 |
| | | 000100 |
| | | 000101 |
| P14 | 00100 | 001001 |
| P16 | 001010 | 001010 |
| P17 | 001011 | 001011 |
| P13 | 0011 | |
| P5 | 01 | 010000 |
| | | 010101 |
| P6 | 10 | 100010 |
| | | 101011 |
| | | 101111 |
| P10 | 110 | 110000 |
| | | 110010 |
| | | 110011 |
| | | 110110 |
| P11 | 111 | 111000 |
| | | 111010 |

For building the PHT binary tree, two rules are used:
Each leaf contains a limited number of keys. This maximum value is hereafter denoted B.
Each internal node contains at most B+1 in its subtree.

As a result of these two rules, if one leaf ends up containing more keys than the limit B, it becomes an internal node, and two new leaves are created as its children. These keys are distributing among the two child leaves.

For example, if a sufficiently high number of keys is added to leaf P11, two new leaves are created from p11: A left leaf p11a labeled “1110” and a right leaf pub labeled “1111”. Node p11 then becomes an internal node.

Conversely, if an internal node does not have enough keys in its subtree, then subtree leaves are merged with their parent internal node.

For example, if leaves p10 and p11 no longer contain enough keys, they disappear, and their keys are saved in node p7, which then becomes a leaf.

Furthermore, each key appears only once in the key-to-leaf associations. Though a single leaf may contain multiple keys (as given as an example in the table), a single key is assigned to only one leaf.

Furthermore, in order to optimize the data structure, each leaf on the binary tree can have a pointer towards the leaves located to its immediate right and left. Thus, for example, leaf p6 has pointers to leaves p5 and p10; leaf p13 has pointers to leaves p5 and p17.

As stated above, such a binary tree is built “above” a distributed hash table DHT

There are various possible implementations for a distributed hash table.

FIG. 1 depicts a simplified example in order to be easily understood, but the invention should not be understood as being limited to this particular implementation.

The set of nodes X₁, X₂, X₃ . . . X_{N} of the distributed hash table DHT plays the same role. In order to save or recover a value in this table (or network), any one of these nodes may be contacted.

In the example given in FIG. 1, mentioned above, a device D queries the node X₃ by providing it with a logic address.

This node calculates a hash function H based on the logic address provided.

A hash function is a function used to convert a value belonging to a large-sized set (the set of all possible logic addresses) into a second value belonging to a smaller-sized set. Here, this second value is a number between 1 and N inclusive, where N is the number of nodes in the distributed hash table DHT.

The hash function H must generally abide by the following mathematical property: H(x)≠H(y) [symbol] x≠y

Furthermore, if x=y, then the probably must be high, as H(x)=H(y).

The function H is ideally suited for achieving uniform key distribution within the addressing space. This distribution tends towards uniformity with a large number of keys.

The value i returned by the hash function lets node X₃ deduce that node Xᵢ is probably the one that possesses the association between the logic address received and the corresponding domain. It transmits this request to the node Xᵢ. If this node does indeed possess the association, it may return the domain associated with the logic address. Otherwise, it may transmit the request to another (neighboring) node that might possess the association.

Through iterations, the algorithm converges closer and closer towards the node that actually possesses the association.

The principle of saving a new association is similar. Any node on the peer-to-peer DHT network receives a save request and calculates a value based on based on the hash function and the logic address.

This value determines a particular node from among all the nodes of the distributed hash table DHT, and the first node resends the save request to that particular node. The assigned node saves the association.

In a situation of the invention where a PHT binary tree is used, the labels of the PHT binary tree's nodes are distributed within the hash table DHT. In specific terms, to save a label, the hash function H is applied to that label, and the binary tree node is saved on the hash table node determined by the value returned by the hash function H.

In the invention, the keys contain at least one service identifier and are associated with a piece of location information. For example, they may contain a physical address, an IP address/port pairing, etc.

The keys may also contain other information, such as the transport protocol to use, for example.

The structure of a key may be as follows;

| | | | |
|---|---|---|---|
| Service identifier | transport | IP Address | Port |

This key may, for example, be 72-bit, if the address is IPv4. The service identifier takes up 16 bits, the transport protocol 8 bits, the IPv4 address 32 bits, and the port 16 bits.

The transport protocol indication typically uses a value defined by the IANA (Internet Assigned Numbers Authority).

For an IPv6 address, it is 128 bits long.

Naturally, other fields may be added without departing from the scope of the invention.

For example, all or some of the parameters that define a universal resource identifier, or URI, as given in IETF RFC 1630, may be added to the key structure or the label.

Thus, the invention has the additional advantage that it can integrate all (or a subset) of the parameters of a URI as given in RFC 1630. This would not be possible when using a conventional peer-to-peer approach, such as those mentioned above, because the indexes used in a peer-to-peer network are binary numbers, and because a URI is an ASCII string. By using the PHT binary tree, the invention makes it possible to use all (if needed) of the a URI's ASCII parameters.

The keys correspond to the leaves on the PHT binary tree.

More precisely, as described above, each key is saved in the leaf whose label is a prefix of a key.

The labels (which are generally smaller than the keys) are distributed, as explained above, in the nodes of the distributed hash table DHT.

It has also been shown above that the distributed hash table DHT is designed to receive location requests. These requests contain at least one service identifier.

Furthermore, they have search means for searching for one or more pieces of location information that provide the service denoted by this service identifier.

To do so, the search means are designed to search within the PHT binary tree for the keys contained in the leaf or leaves whose labels correspond to the service identifier.

Several search methods are possible. Some are set forth in the above-cited article by Sriram Ramabhadran, Sylvia Ratnasamy, Joseph M. Hellerstein, and Scott Shenker.

For example, if the request contains the “STUN” service's identifier, the search means may search for a node providing this STUN service, or several nodes providing it, or even all nodes providing it. In other words, if multiple nodes “STUN 1”, “STUN 2”, “STUN 3”, . . . provide the same service, it is not necessary for the sender of the request to specify which node it is contacting. The mechanism is transparent, and it does not even need to know how many nodes are providing the requested service.

Particularly owing to the use of pointers between neighboring leaves, it is possible to easily conduct interval searches. Also, the location request may contain a service identifier like “STUN” without specifying if it is “STUN 1”, “STUN 2”, etc. The search means must then find all or some of the corresponding leaves.

The number of replies that the distributed hash table must search for may be specified in the location request; for example, if the sender only wants N nodes providing the service, or the set of all nodes providing the service.

The keys saved in the leaves found by the search contain location information, which correspond to the nodes of the distributed hash table that provide the requested service. As shown above, they may be binary fields with short keys.

This location information is returned to the sender of the location request. It may then use them to contract the node(s) of the distributed hash table DHT.

FIG. 4 shows an example application of the invention for locating a STUN service within a communication network.

Four devices, N₁, N₂, N₃, N₄ are connected within the distributed hash table DHT. A subnetwork SN “isolates” the node N₂ from the other nodes N₁, N₃ and N₄. A network address translator NAT connects this subnetwork SN to the rest of the communication network.

Some of these nodes provide the STUN service, and are represented by hatching in the figure. They are nodes N₁, N₂ and N₄.

To be able to produce the results and the function desired, a STUN service must be located in the public space of a communication network. It must not be in a sub-network isolated from the public space by a NAT device. The very fact that the equipment requesting the service is itself known within a private sub-network is not enough to conclude that the STUN service located on the other side of a NAT device is automatically in public space, as the sub-networks may be nested within one another.

To resolve this problem, a node that is known to belong to public space is initially defined as a provider of the STUN service. It acts as a bootstrap.

In FIG. 4, this is node N₁.

This initial assignment may be made manually or by an automatic mechanism outside the invention.

Each node in the distributed hash table DHT, which includes the STUN function, may then itself be tested, via the STUN mechanism, in order to tell whether it is within public space or behind a NAT device.

To do so, in a known manner, node N₄, for example, transmits a STUN request to node N₁. N1 returns to N4 the IP addresses that it sees it as having. As no NAT device is found between the two nodes, the address observed by node N₁ is the “real” address of node N₄. N4 can therefore tell that it is in public space, and adds itself to the distributed hash table DHT as a provider of the STUN service.

Node N₂ can do the same with one of the nodes providing the STUN service, i.e. either node N₁ or node N₄.

However, this time, the queried node returns a address that is different from N₂'s known address. It can then conclude from this that it is located within a sub-network SN, separated from the public area by a NAT device.

It therefore does not add itself to the list of nodes providing the STUN service.

Adding a node to the list is done using the method described above. First, a key is constructed based on a STUN service identifier and a piece of location information, such as its IP address and the port. The key is then saved within a PHT binary tree whose labels are distributed within the distributed hash table DHT.

A device D located within a sub-network SN2, and behind a network address translator NAT2, wants to access a STUN service. To do so, it transmits a location request to the distributed hash table DHT. As explained above, the distributed hash table DHT then searches the saved information and returns either the two addresses of N₁ and N₄, or just one of them.

The device D may then contact a particular node of this distributed hash table to obtain the STUN service.

1. A communication network (NET) including a distributed hash table (DHT) whose nodes (X₁, X₂, X₃ . . . X_{N}) provide services that may be accessed by network elements (T) connected to said telecommunication network, said distributed hash table (DHT) having:
means for receiving a service location request (R) from a network element (T), said request containing at least one service identifier (ID), and
search means for searching for at least one piece of location information within said hash table, with each one corresponding to a node providing the service denoted by said service identifier, and to transmit it or them to said network element,
characterized in that said hash table is organized so that the location information is associated with keys containing at least one service identifier, and which correspond to leaves on a PHT binary tree whose nodes' labels are distributed within said distributed hash table, and
in that the search means are designed for search for location information in all or some of the leaves whose labels are prefixes of the service identifier contained within said service request, and to transmit them to said network element.

2. A communication network according to claim 1, in which said network element (T) is a communication client, particularly a communication client designed to communicate using the SIP protocol.

3. A communication network according to claim 2, in which said communication client is a communication terminal.

4. A communication network according to claim 1, in which said labels and said keys are binary words, said labels being formed in such a way so that the weight of each bit, in descending order, corresponds to an increasing level of depth within said binary tree.

5. A communication network according to claim 1, in which said services are STUN and/or TURN and/or comply with the IETF's RFC 3489bis.

6. A communication network according to claim 1, in which said node is one of the nodes (X₁, X₂, X₃ . . . X_{N}) of said distributed hash table (DHT).

7. A communication network according to claim 1, in which said labels are made up of at least one service identifier, a transport protocol indication, a piece of location information, and a port.

8. A communication network according to the claim 7, in which said labels further include all or some of the parameters that define a universal resource identifier URI in accordance with the IETF's RFC 1630.

9. A method enabling a communication device (D) to access a service provided by a distributed hash table (DHT), including a step of transmitting a service location request, said request containing an identifier of said service; and a step of searching said distributed hash table for at least one piece of location information, each one corresponding to a node providing said service
characterized in that the search step consists of searching for a key in a PHT binary tree whose nodes' labels are distributed within said distributed hash table, said key containing at least said identifier, the search consisting of searching the location information in all or some of the leaves whose label prefixes said service identifier.

10. A method according to claim 9, in which said network element (T) is a communication client, particularly a communication client designed to communicate using the SIP protocol.

11. A method according to the claim 10, in which said communication client is a communication terminal.

12. A method according to claim 9, in which said labels and said keys are binary words, said labels being formed in such a way so that the weight of each bit, in descending order, corresponds to an increasing level of depth within said binary tree.

13. A method according to claim 9, in which said services are STUN and/or TURN and/or comply with the IETF's RFC 3489bis.

14. A method according to claim 9, in which said node is one of the nodes (X₁, X₂, X₃ . . . X_{N}) of said distributed hash table (DHT).

15. A method according to claim 9, in which said labels are made up of at least one service identifier, a transport protocol indication, a piece of location information, and a port.

16. A method according to claim 15 in which said labels further include all or some of the parameters that define a universal resource identifier URI in accordance with the IETF's RFC 1630.

17. A computer program designed to perform the method according to claim 9, whenever it is implemented on an information processing device.

18. A computing medium containing a computer program according to claim 17.
